(19) United States
(12) Patent Application Publication
(10) Pub. No.: US 2025/0321853 A1
(43) Pub. Date: Oct. 16, 2025

(54) BATCH SYSTEM ANALYSIS DEVICE AND BATCH SYSTEM ANALYSIS METHOD

(71) Applicant: Hitachi, Ltd., Tokyo (JP)

(72) Inventors: Jinan DAI, Tokyo (JP); Tadahisa KATO, Tokyo (JP); Shinji ITOH, Tokyo (JP); Yasuhiro YOSHINO, Tokyo (JP); Makoto KIMURA, Tokyo (JP)

(21) Appl. No.: 19/019,608

(22) Filed: Jan. 14, 2025

(30) Foreign Application Priority Data
Apr. 15, 2024 (JP) 2024-065816

(51) Int. Cl. G06F 11/34

(52) U.S. Cl. CPC G06F 11/3452; G06F 11/3419

(57) ABSTRACT

Information for specifying a place to divide a batch system is provided. A batch system analysis device includes: a time series analysis unit that analyzes an execution sequence of a job constituting a batch system based on schedule information instructing execution of the job, and obtains job execution sequence information; an I/O information analysis unit that obtains job I/O information indicating input/output of data to be used in the job from a source code of the job; a dependency analysis unit that obtains dependency information between jobs from the job I/O information; a separation information analysis unit that obtains separation information, which is a place where the batch system can be separated from the execution sequence information and the dependency information; and an output unit that outputs the separation information.

### CROSS-REFERENCE TO RELATED APPLICATION

The present application claims priority from Japanese application JP2024-065816, filed on Apr. 15, 2024, the content of which is hereby incorporated by reference into this application.

### TECHNICAL FIELD

The present invention relates to a batch system analysis device and a batch system analysis method.

### BACKGROUND ART

In a batch system operated using a computer such as a mainframe computer, the system has become complicated due to long-time modification, and there are many cases where no document describing the entire batch system exists or such a document is not updated.

The number of engineers who use the COBOL language, which has been generally used for development of a batch system, is also reduced, and even if there is a source program corresponding to a current batch system, it is difficult for an engineer to analyze the operation of the batch system.

Under such circumstances, there is a demand for new modifications such as countermeasures against failures occurring in the current system, transition from a mainframe computer to a cloud system, online systemization, and computer resource optimization.

In order to cope with such problems, analysis of a batch system is necessary, and PTL 1 discloses a job analyzing apparatus in which a plurality of jobs included in log data are classified according to which time segment among a plurality of time segments does the end time of those jobs belong.

Then, for a plurality of jobs included in the first time segment, first data showing the execution sequence relation of the jobs are generated based on the end time of the jobs, and for a plurality of jobs included in a second time segment succeeding the first time segment, second data showing the execution sequence relation of the jobs are generated based on the end time of the jobs.

Then, the execution sequence relation between the jobs included in the first time segment and the jobs included in the second time segment is analyzed based on the end time of the jobs included in the first time segment and the end time of the jobs included in the second time segment, and data showing the execution sequence relation of the jobs transferred from the first time segment to the second time segment are generated.

### CITATION LIST

### Patent Literature

PTL 1: JP 2011-128828 A

### SUMMARY OF INVENTION

### Technical Problem

The method of PTL 1 is an analysis device that generates data indicating a relation in the execution sequence of the jobs from the end time of the jobs using log data that is a record of execution of the jobs.

Therefore, it is conceivable that the end time of the jobs changes when an error occurs during the execution of the jobs or when the content or amount of input data of the jobs changes.

There is a possibility that different jobs are executed depending on the input data, and it is conceivable that the operation of an actual batch system and the data indicating the relation in the execution sequence of the jobs that is the output of the analysis device do not match.

Furthermore, in the method of PTL 1, dependency between jobs regarding files input/output by the jobs is not analyzed, and there is a problem that a job analysis result regarding the dependency between the jobs cannot be obtained.

When a generally large-scale batch system is modified, modifying the entire batch system at a time is difficult in terms of technique and cost, the batch system is divided into several parts, and the divided parts are modified.

Therefore, unless division is performed at an appropriate portion, a modified part cannot be operated together with a part not to be modified.

In order to solve this problem, it is necessary to analyze not only the execution sequence of the job but also the dependency of the job.

### Solution to Problem

The above problem is achieved by a batch system analysis device, including: a time series analysis unit that analyzes an execution sequence of a job constituting a batch system based on schedule information instructing execution of the job, and obtains job execution sequence information; an I/O information analysis unit that obtains job I/O information indicating input/output of data to be used in the job from a source code of the job; a dependency analysis unit that obtains dependency information between jobs from the job I/O information; a separation information analysis unit that obtains separation information, which is a place where the batch system can be separated from the execution sequence information and the dependency information; and an output unit that outputs the separation information.

### Advantageous Effects of Invention

Information for specifying a place to divide a batch system can be provided.

### BRIEF DESCRIPTION OF DRAWINGS

FIG. 1 is an example of a block diagram illustrating a configuration diagram of a batch system analysis device in an example of the present invention.

FIG. 2 is a view describing a jobnet constituting a batch system.

FIG. 3 is a view schematically illustrating a jobnet.

FIG. 4 is a view describing schedule information.

FIG. 5 is a view describing CRUD information.

FIG. 6 is an example of batch configuration information representing a call relation of a job in an example of the present invention.

FIG. 7 is an example of data dependency information of a job in an example of the present invention.

FIG. 8 is an example of batch I/O information in an example of the present invention.

FIG. 9 is an example of a view illustrating a dependency of a job when time series is not considered in an example of the present invention.

FIG. 10 is an example of batch schedule information representing a startup schedule of a job in an example of the present invention.

FIG. 11 is an example of a view illustrating dependency of a job based on time series in an example of the present invention.

FIG. 12 is a view describing a relation in time series units of jobs in an example of the present invention.

FIG. 13 is an example of separation information in an example of the present invention.

FIG. 14 is an example of an analysis screen in an example of the present invention.

FIG. 15 is an example of a flowchart showing processing of the batch system analysis device in an example of the present invention.

FIG. 16 is an example of a flowchart of processing of creating batch I/O information from information of a source file in an example of the present invention.

### DESCRIPTION OF EMBODIMENTS

Examples of the present invention will be described below with reference to the drawings. Note that in the drawings for describing the examples, the same constituent elements are denoted by the same names and reference signs as much as possible, and repeated description thereof will be omitted.

The present invention is not limited to the examples described below but includes various variations and equivalent configurations within the scope of the appended claims. For example, the above-described examples have been described in detail for the purpose of describing the present invention in an easy-to-understand manner, and the present invention is not necessarily limited to those including all the configurations described above.

Some or all of the processing units and the processing modules described in the examples may be implemented by hardware by being designed as an integrated circuit or the like, or may be implemented by software by a processor interpreting and executing a program for implementing each function.

The information described in the examples may be a table, a database (DB), or data stored in a main storage memory.

### Examples

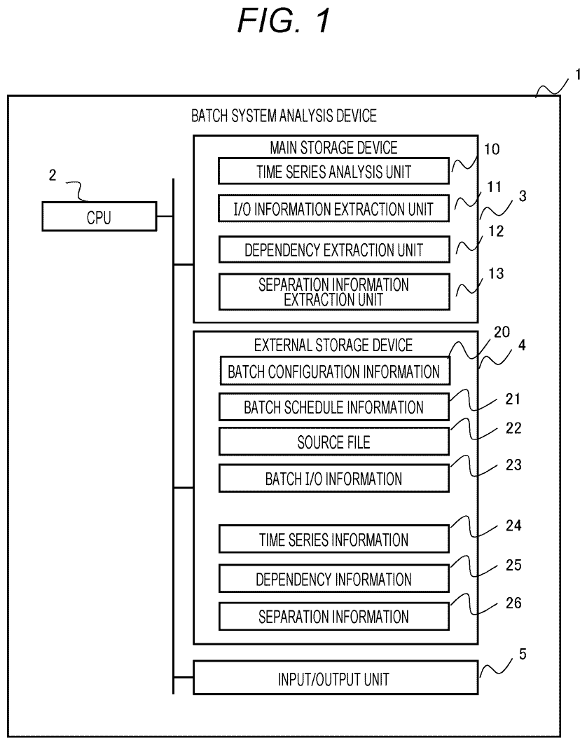

FIG. 1 is an example of a block diagram illustrating a configuration diagram of a batch system analysis device in an example of the present invention.

In the present example, an example in which a batch system analysis device 1 is implemented by a stand-alone computer including a processing device including a central processing unit (CPU) 2, a main storage device 3 including a random access memory (RAM) and a read only memory (ROM), an external storage device 4 including a hard disk drive (HDD) and a solid state drive (SSD), and an input/output unit 5 including a network interface card (NIC) will be described, but the batch system analysis device 1 may be implemented by using a cloud system that provides computer resources.

The main storage device 3 stores a time series analysis unit that analyzes execution sequences of jobs and jobnets in time series, an I/O information extraction unit 11 that analyzes input/output of jobs, a dependency extraction unit 12 that analyzes the dependency of jobs based on the execution sequence of jobs and the dependency of data to be used, and a separation information extraction unit 13 that obtains information for separating the batch system.

These processing units are implemented as software modules, and are executed by the CPU 2 with reference to information stored in the external storage device 4.

The external storage device 4 stores batch configuration information 20, batch schedule information, a source file 22, and batch I/O information 23, and the processing unit stored in the main storage device 3 performs analysis based on these pieces of information to create time series information 24, dependency information 25, and separation information 26.

These pieces of information may be in the form of an independent file or table, or may be described in the JASON format in which a plurality of pieces of information are stored in one file.

The input/output unit 5 receives, from the user, designation of information such as the batch configuration information 20 of the batch system, and outputs and provides, to the user, a result processed by each processing unit stored in the main storage device 3 based on the received information.

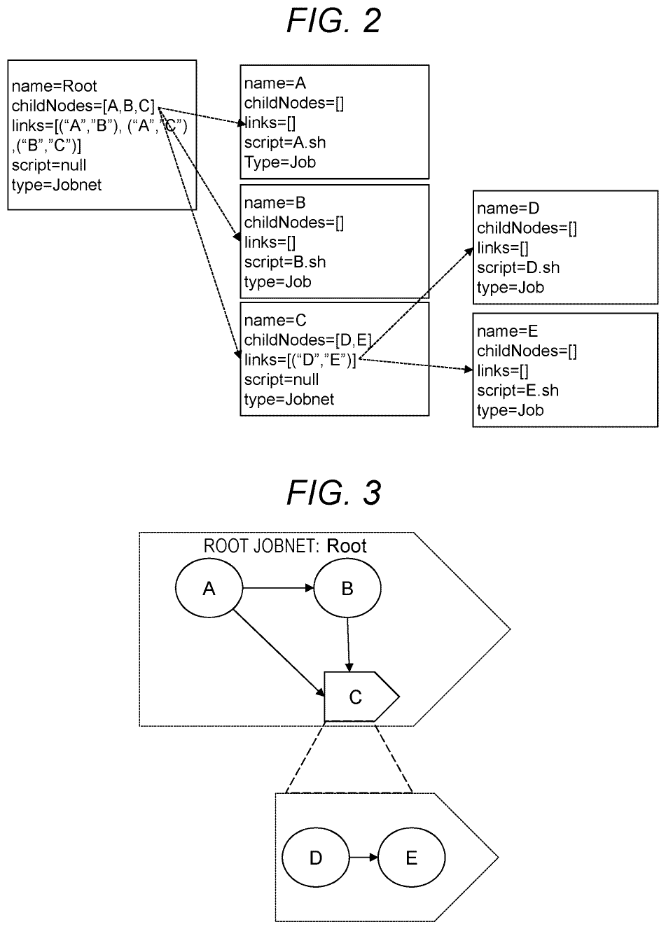

FIG. 2 is a view describing a jobnet constituting a batch system.

In this example, an example of a batch system described in a JavaScript object notation format will be described. The batch system includes an array of a plurality of root jobnets, and is expressed in a format of batch processing=[root jobnet 1, root jobnet 2, root jobnet 3, . . . ].

The configuration information of one jobnet has a tree structure. The root of a tree is a root jobnet, and a job or a jobnet included in the jobnet is stored in an identifier childNodes. A pointer to a jobnet or a job is stored in an identifier links.

In a case of a jobnet, a value defined by the following identifier is held.
name: Name of jobnet
childNodes: Name of jobnet or job included in jobnet
links: Pointer indicating jobnet or job to be executed
type: Set to “Jobnet”
In a case of a job, a value defined by the following identifier is held.
name: Name of job
childNodes: Empty value
links: Empty value
script: Pointer to script executed by job
type: Set as “Job”

In this example, an example of a configuration is defined in which a jobnet having a name Root calls a job A, a job B, and a lower jobnet C, and the lower jobnet C calls a job D and a job E.

FIG. 3 schematically illustrates the batch configuration information 20 described in a source code in the JSON format illustrated in FIG. 2. Those indicated by circles are jobs, one indicated by an arrow is a jobnet.

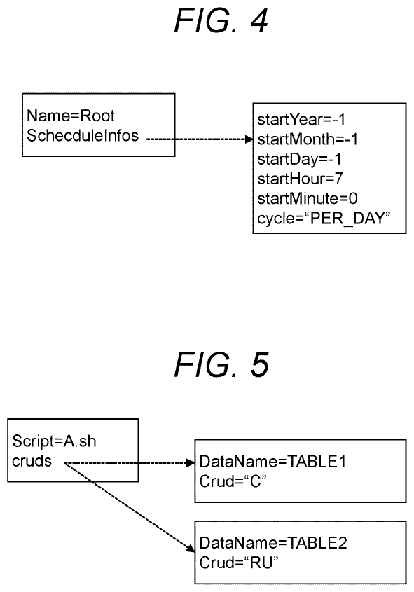

FIG. 4 is a view illustrating schedule information.

The schedule information includes a name of a root jobnet and a plurality of schedule details, and the root jobnet is executed in accordance with one or a plurality of schedules.

The schedule information has the following data structure.
name: Name of root jobnet
scheduleInfos: All schedule details of root jobnet
startYear: Execution start year of root jobnet
startMonth: Execution start month of root jobnet
startDay: Execution start date of root jobnet
startHour: 0-23 is designated at execution start “time” of root jobnet
startMinute: 0-59 is designated at execution start “minute” of root jobnet
cycle: Execution cycle of root jobnet

The value of an item not designated is −1. In a case of daily, cycle = “PER DAY”. In a case of monthly, cycle=“PER_MONTH”. Date is designated with startDay. In a case of designating “end of month”, “32” is designated. In a case of weekly, cycle=“PER_WEEK”. The day of the week is designated with startDay. Monday to Sunday are designated with 1 to 7.

In a case of performing execution every X days, Cycle=“X”. The first execution date is designated by startYear, startMonth, and startDay. In a case where the first execution date is Jul. 7, 2006, startYear=2006, startMonth=7, and startDay=7.

In this example, a job with a name Root is started daily at 7:00 am.

FIG. 5 is a view illustrating CRUD information.

The CRUD information includes a name of a script and CRUD of the script, and a data structure is as follows.
Script: Name of script
cruds: All pieces of CRUD information of script
DataName: Name of access data
crud: Operation content for data

The operation content is expressed by C, R, U, and D, meaning C: Create, R: Read, U: Update, and D: Delete.

In this example, it is defined that a script A.sh creates TABLE1 and reads and updates TABLE2.

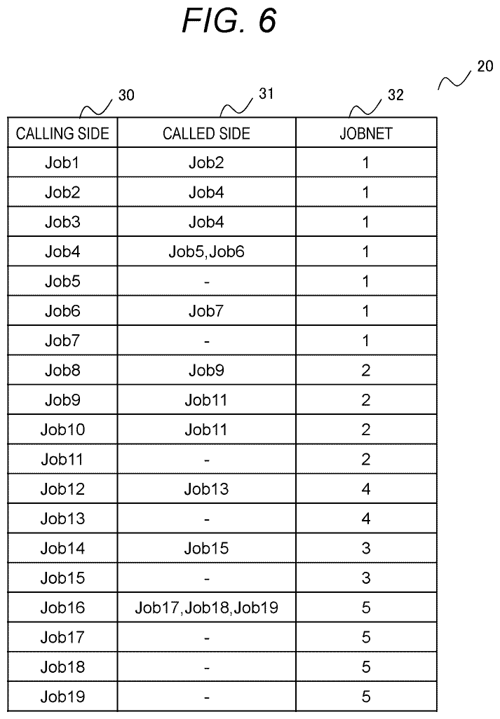

FIG. 6 is an example of the batch configuration information 20 representing a call relation of a job in an example of the present invention.

A table indicating a call relation is created based on schedule information of the job described in the JSON format. A job 30 on a calling side, a job on a called side, and a jobnet 32 including the job are stored in association with one another.

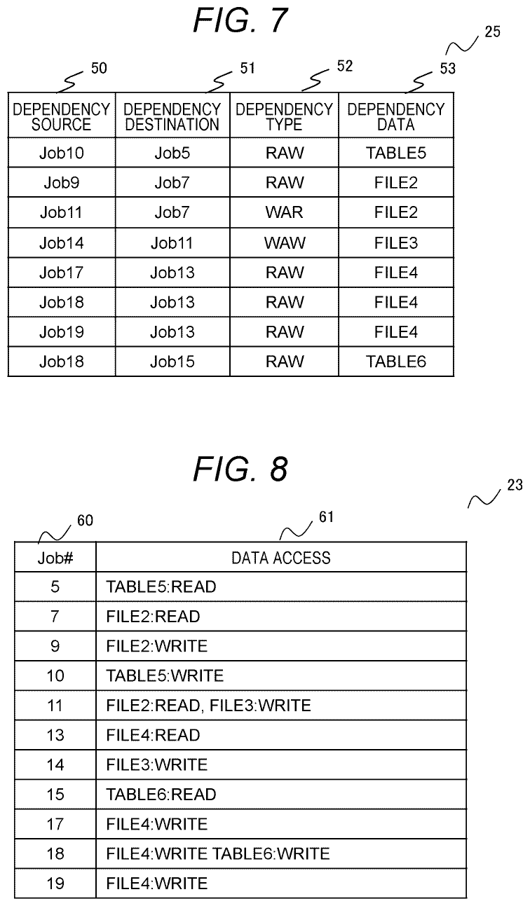

FIG. 7 is an example of data dependency information of a job in an example of the present invention.

The dependency information 25 stores a dependency source 50, which is a job name of a dependency source, a dependency destination 51, which is a job name of a dependency dependency type 52 indicating which of Read After Write (RAW), Write After Read (WAR), and Write After Write (WAW) the dependency is, and dependency data 53, which is a name of dependency data, in association with one another.

Here, the type of dependency will be described. For example, in a case where there is RAW dependency in which the content output by a job K is read by a job J, if division is performed ignoring this dependency, reading of the job J is performed first, and data inconsistency occurs.

In a case where there is WAR dependency in which the job J writes again the data written by the job K, if division is performed ignoring this dependency, the write sequence of the job J and the job K changes, and data inconsistency occurs when a subsequent job Z reads data.

In a case where there is WAR in which the job J writes again the data read by the job K, if division is performed ignoring this dependency, the execution result of the job K changes due to a change in the execution sequence of the job J and the job K, and data inconsistency occurs.

FIG. 8 is an example of batch I/O information in an example of the present invention.

The batch I/O information 23 stores, in association with each other, Job #60 indicating a job number, and data access 61 indicating a pair a name of data accessed by a job and READ/WRITE of an access type.

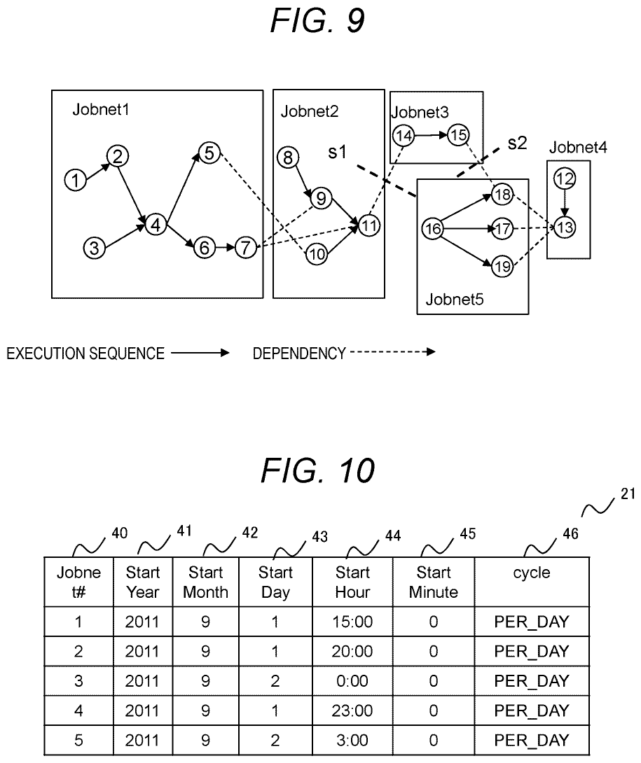

FIG. 9 is an example of a view illustrating job dependency when time series is not considered in an example of the present invention.

The call relation of the job illustrated in FIG. 6 and the dependency based on the presence or absence of the dependency information of the data illustrated in FIG. 7 are illustrated in a valid diagram. A solid arrow indicates an execution sequence based on a call relation, and a thin dotted line indicates dependency of data.

In this example, data dependency from Jobnet3 to Jobnet2 has only dependency of a job 14 on a job 11. Data dependency from Jobnet5 to Jobnet3 has only dependency from a job 18 to a job 15. Therefore, two points of a division point s1 and a division point s2 indicated by thick dotted lines are candidates for division.

Here, the job execution schedule will be examined.

FIG. 10 is an example of batch schedule information representing a startup schedule of a job in an example of the present invention.

FIG. 10 is the schedule information described in the JSON format rewritten into a table format. Job name Job #40, StatrtYear41 of the execution year, StartMonth42 of the execution month, StaratDay43 of the execution day, StartHour of the execution hour, StartMinute45 of the execution minute, and cycle46 of the execution cycle are stored in association with one another.

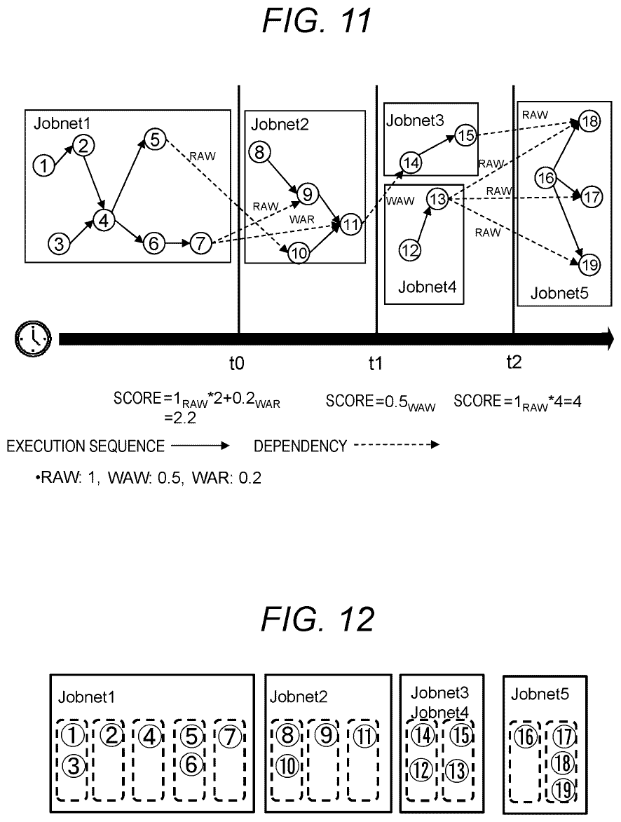

FIG. 11 is an example of a view illustrating dependency of a job based on time series in an example of the present invention.

FIG. 11 is the valid diagram of FIG. 6 reordered based on the schedule of FIG. 9. In a time series order, it is found that the division point s1 (t=t1) between Jobnet3 and Jobnet2, which is a division candidate portion with the dependency in FIG. 9 has only the data dependency from the job 14 to the job 11, but the division point s2 (t=t2) between Jobnet5 and Jobnet3 has data dependency from the job 18 to a job 13, data dependency from a job 17 to the job 13, and data dependency from a job 19 to the job 13.

As candidates of the division point, there is no dependency of the execution sequence between Jobnet1 and Jobnet2 at t=t0, and only data dependency is present. Considering that the number of data dependencies at t=t2 is 4, it is found that there is a division candidate portion because the number of data dependencies is 3 at t=0.

FIG. 12 is an example of a view illustrating dependency of a job based on time series in an example of the present invention.

When the execution sequence in the jobnet is simulated (extracted), by a simulation algorithm, a set of jobs that start execution in parallel is a time series unit.

Furthermore, in a case where there is a jobnet that simultaneously starts execution, there is also a case where there are jobs belonging to a plurality of jobnets in one time series unit.

When the jobnet of FIG. 11 is divided in time series units, it will be as in FIG. 12. According to an illustration of the execution sequence of the jobnet 1, a job 1 and a job 3 simultaneously start execution. A job 5 and a job 6 also simultaneously start execution.

Therefore, the job 1 and the job 3 belong to the same time series unit, and the job 5 and the job 6 belong to the same time series unit.

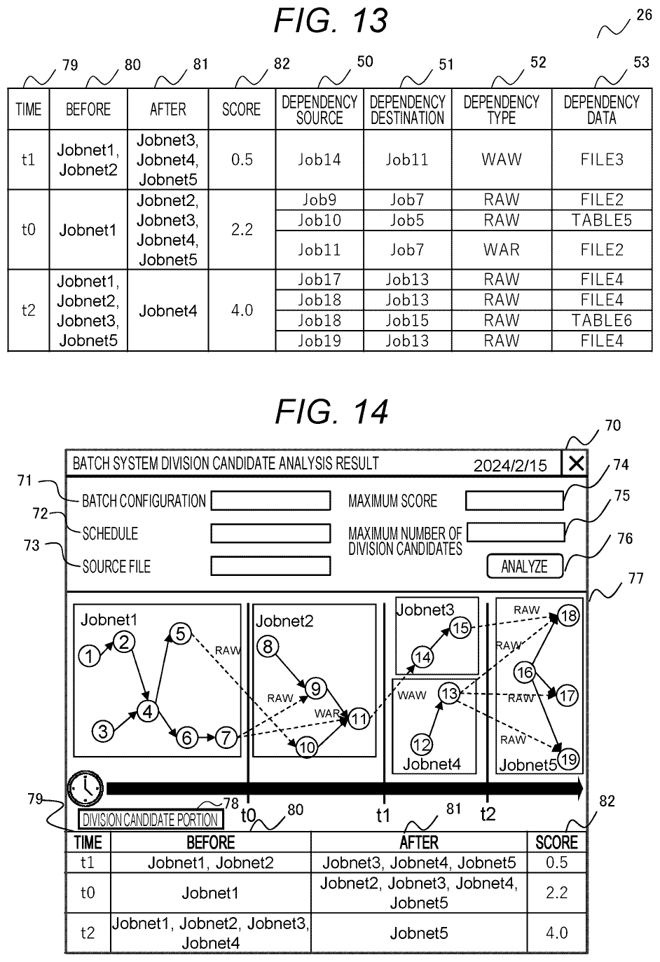

FIG. 13 is an example of separation information in an example of the present invention.

The separation information 26 stores, in association with one another, time 79 of separation, a processed jobnet 80, an unprocessed jobnet 81, a score 82 representing a separability index (difficulty level) obtained at the separation candidate point, the dependency source 50, which is a dependency source job name of data dependency, the dependency destination 51, which is a dependency destination job name of data dependency, the dependency type 52 of data dependency, and the dependency data 53, which is a name of dependency data.

In this example, they are sorted in ascending order of the score and stored. The score is calculated based on the number of dependencies and the weight in accordance with the type of dependency.

In this example, calculation is performed with the weight of RAW as 1, the weight of WAW as 0.5, and the weight of WAR as 0.2. Since at t=t0, the dependency of RAW is 2, and the dependency of WAR is 1, the score is 1*2+0.2=2.2.

Similarly, the score is 0.5 at t=t1 and 4 at t=t2, and the magnitude of dependencies is in the order of t1<t0<t2.

FIG. 14 is an example of an analysis screen in an example of the present invention. Input of information indicating the batch system of analysis targets such as a batch configuration 71, a schedule 72, and a source file 73 is received. In the present example, an example of a screen for inputting each piece of information is described, but in a case where information indicating batch systems is included in one file, only one file name may be designated.

When the designation of a maximum score 74, which is an upper limit of the difficulty level of division, or a maximum number 75 of division candidates to be displayed is received at the time of division, it is possible to display only division candidate portions that are highly worth examining.

An analysis is started by pressing an analysis button 76, and an analysis screen 77 that displays dependency using an oriented diagram and a division candidate portion 78 that is a result of calculating the score of each division point candidate are output.

In the division candidate portion 78, the division candidate indicated by the time 79, the processed jobnet 80, the unprocessed jobnet 81, and the score 82 at the time are displayed in association with one another.

By designating a division point candidate for which a score is to be calculated with an arrow indicating the time axis illustrated on the analysis screen 77 and pressing the analysis button 76, it is possible to obtain a score of an arbitrary division point candidate on the displayed time axis.

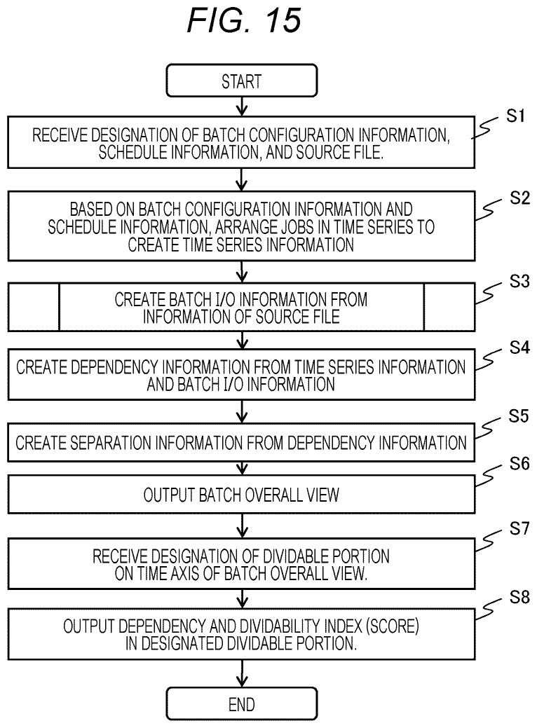

FIG. 15 is an example of a flowchart showing processing of a batch system analysis device in an example of the present invention.

First, designation of the batch configuration information 20, schedule information, and a source file is received from the user (S1).

Next, based on the batch configuration information 20 and the schedule information that are received, the time series analysis unit 10 creates the batch configuration information 20 and arranges the jobs in time series to create time series information (S2).

The I/O information extraction unit 11 creates the batch I/O information 23 from the information of the source file (S3), and the dependency extraction unit 12 creates the dependency information 25 from the time series information and the batch I/O information (S4).

The separation information extraction unit 13 creates the separation information 26 from the dependency information 25 (S5), and the input/output unit 5 outputs an analysis screen 70 including a batch overall view (S6).

On the analysis screen 70, the input/output unit 5 receives designation of a dividable portion on the time axis of the batch overall view (S7). The separation information extraction unit 13 obtains, and the output unit outputs, to the division candidate portion 78, the dependency and the dividability index (score) in the designated dividable portion (S8).

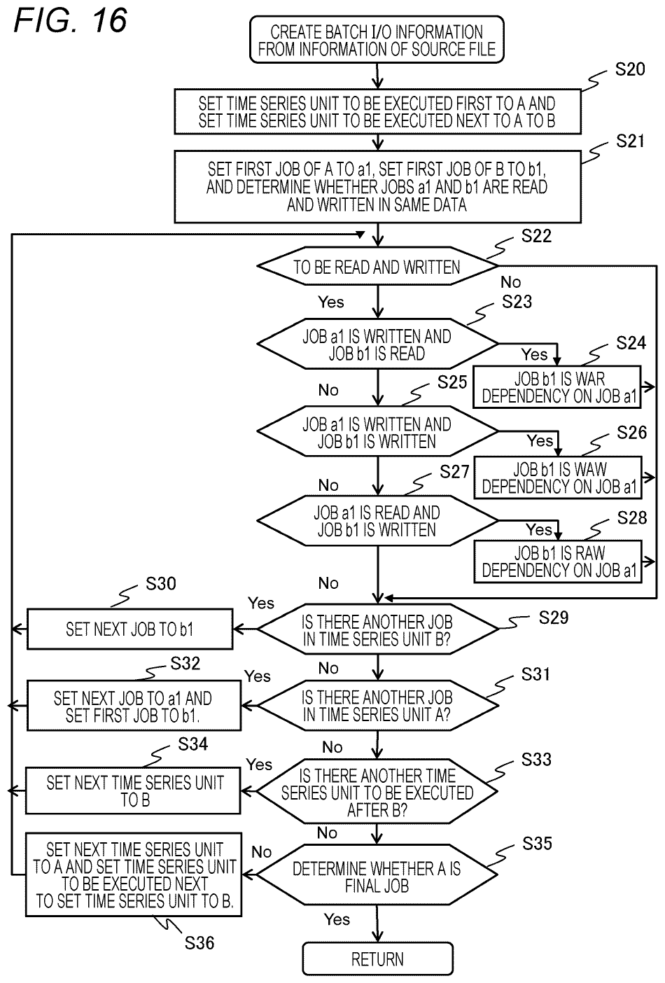

FIG. 16 is an example of a flowchart of processing of creating batch I/O information from information of a source file in an example of the present invention.

The dependency extraction unit 12 sets the time series unit to be executed first to A, sets the time series unit to be executed next to A to B (S20), sets the first job of A to a1, sets the first job of B to b1, and determines whether jobs a1 and b1 are read and written in the same data (S21).

In the case of being read and written, if the job a1 is to be written and the job b1 is to be read (S23), it is determined that the job b1 is WAR dependency on the job a1 and is described in the dependency type 52 of the dependency information 25 (S24).

If the job a1 is to be written and the job b1 is to be written (S25), it is determined that the job b1 is WAW dependency on the job a1 and is described in the dependency type 52 of the dependency information 25 (S26).

If the job a1 is to be read and the job b1 is to be written (S27), it is determined that the job b1 is RAW dependency on the job a1 and is described in the dependency type 52 of the dependency information 25 (S28).

If No in (S27) or after the dependency type is determined and the dependency type is stored in the dependency type 52 of the dependency information 25, it is determined whether there is another job in the time series unit B (S29). If there is the next job is set in b1, and the process returns to S22 (S30).

If there is no other job in B, it is determined whether there is another job in the time series unit A (S31), and if there is, the next job is set in a1, the first job is set in b1, and the process returns to S22 (S32).

If there is no other job in A, it is determined whether there is another time series unit to be executed after the jobnet B (S33), and if there is, the next time series unit is set in B and the process returns to S22 (S34).

If there is no other job in B, it is determined whether A is a final job (S35), and if it is not the final job, the next time series unit is set in A, the time series unit to be executed next to the set jobnet is set in B, and the process returns to S22 (S36). If the job is the final job, the process ends and returns.

By this process, data dependency between jobs included in all time series units in the batch system can be examined.

### REFERENCE SIGNS LIST

1 batch system analysis device
2 CPU
3 main storage device
4 external storage device
5 input/output unit
10 time series analysis unit
11 I/O information extraction unit
12 dependency extraction unit
13 separation information extraction unit
20 batch configuration information
21 batch schedule information
22 source file
23 batch I/O Information
24 time series information
25 dependency information
26 separation information

1. A batch system analysis device, comprising:
a time series analysis unit that analyzes an execution sequence of a job constituting a batch system based on schedule information instructing execution of the job, and obtains job execution sequence information;
an I/O information analysis unit that obtains job I/O information indicating input/output of data to be used in the job from a source code of the job;
a dependency analysis unit that obtains dependency information between jobs from the job I/O information;
a separation information analysis unit that obtains separation information, which is a place where the batch system can be separated from the execution sequence information and the dependency information; and
an output unit that outputs the separation information.

2. The batch system analysis device according to claim 1, wherein the schedule information to be analyzed by the time series analysis unit is schedule information described in a JSON format.

3. The batch system analysis device according to claim 1, wherein the I/O information to be obtained by the I/O information analysis unit is information related to reading from a file and writing to the file.

4. The batch system analysis device according to claim 3, wherein
the dependency information obtained by the dependency analysis unit includes a dependency type indicating whether to be WAR in which a first job writes data before a second job reads data,
RAW in which the first job reads data before the second job writes data, or
WAW in which the first job writes data before the second job writes data.

5. The batch system analysis device according to claim 4, wherein the separation information analysis unit obtains the separation information of the batch system in a division candidate portion based on dependency of a job generated in the division candidate portion corresponding to time included in the execution sequence information and a dependency type of the dependency.

6. The batch system analysis device according to claim 5, wherein
the separation information analysis unit obtains a separability index obtained by multiplying and adding up a number of dependencies for each dependency type generated at the division candidate portion by a weight determined in accordance with the dependency type, and
the output unit outputs a processed job, an unprocessed job, and the separability index at the division candidate portion.

7. The batch system analysis device according to claim 6, wherein the output unit outputs a predetermined number of division candidate portions when separability indices are arranged in ascending order.

8. A batch system analysis method, wherein
a time series analysis unit analyzes an execution sequence of a job constituting a batch system based on schedule information instructing execution of the job, and obtains job execution sequence information,
an I/O information analysis unit obtains job I/O information indicating input/output of data to be used in the job from a source code of the job,
a dependency analysis unit obtains dependency information between jobs from the job I/O information,
a separation information analysis unit obtains separation information, which is a place where the batch system can be separated from the execution sequence information and the dependency information, and
an output unit outputs the separation information.
